(19) United States
(12) Patent Application Publication
(10) Pub. No.: US 2019/0232790 A1
(43) Pub. Date: Aug. 1, 2019

(54) VEHICLE BRAKE SYSTEM

(71) Applicant: TOYOTA JIDOSHA KABUSHIKI KAISHA, Toyota-shi (JP)

(72) Inventor: Takayuki HONDA, Toyota-shi (JP)

(73) Assignee: TOYOTA JIDOSHA KABUSHIKI KAISHA, Toyota-shi (JP)

(21) Appl. No.: 16/262,403

(22) Filed: Jan. 30, 2019

(30) Foreign Application Priority Data
Feb. 1, 2018 (JP) 2018-016233

(51) Int. Cl. B60L 7/26

(52) U.S. Cl. CPC B60L 7/26; B60L 2240/12

(57) ABSTRACT

A vehicle brake system including a regenerative brake device and an electric brake device, wherein, in a condition in which no request for an electric braking force is made, the brake system is configured to: (a) in principle, cause a piston of an actuator of the electric brake device to be located at a retracted position at which a clearance between a friction member and a rotary body of the electric brake device is allowed to be equal to a first clearance; and (b) execute a regenerative-braking-force-dependent standby control in which the piston is moved from the retracted position to a standby position at which the clearance does not exceed a second clearance set to be smaller than the first clearance, when a difference between a maximum regenerative braking force that can be generated and an actual regenerative braking force becomes smaller than or equal to a set difference.

### CROSS REFERENCE TO RELATED APPLICATION

The present application claims priority from Japanese Patent Application No. 2018-016233, which was filed on Feb. 1, 2018, the disclosure of which is herein incorporated by reference in its entirety.

### BACKGROUND

### Technical Field

The following disclosure relates to a brake system installed on a vehicle.

### Description of Related Art

In the field of vehicle brake systems, there is proposed a vehicle brake system equipped with an electric brake device configured to generate an electric braking force that depends on a force exerted by an electric motor. The electric brake device is typically configured to generate the braking force such that a piston is advanced by the electric motor so as to push a friction member (such as a brake pad) onto a rotary body (such as a disc rotor) that rotates with a wheel. When there is no request for the electric brake device to generate the braking force (hereinafter referred to as “non-request condition of the electric braking force” where appropriate), it is possible to retract the piston by the electric motor to such an extent that a state in which a sufficient clearance exists between the rotary body and the friction member is established, as described in Japanese Patent Application Publication No. 2012-240632, for instance. Owing to the establishment of the state, it is possible to avoid or reduce, in the non-request condition of the electric braking force, a phenomenon in which the rotary body rotates while being in contact with the friction members, namely, what is called drag phenomenon, for improving the fuel economy of the vehicle, for instance.

### SUMMARY

On the other hand, the clearance is preferably small in terms of good response of the electric brake device, namely, in terms of a shortened length of time from a time point when the request for the electric braking force is made to a time point when the electric braking force is actually generated. In other words, it is preferable to make the clearance small when a probability of generation of the electric braking force becomes high. In a vehicle brake system equipped with both of the electric brake device and a regenerative brake device configured to generate a regenerative braking force utilizing electric power generation by rotation of the wheel, it is desirable to also consider a state of generation of the regenerative braking force to achieve both of avoidance/reduction of the drag phenomenon and good response. Such consideration enables improvement of the utility of the vehicle brake system equipped with the electric brake device and the regenerative brake device. Accordingly, an aspect of the present disclosure is directed to a vehicle brake system having high utility.

In one aspect of the present disclosure, the vehicle brake system includes the electric brake device and the regenerative brake device described above and is configured such that the electric braking force covers an insufficient braking force which is a shortage in a required overall braking force required for the vehicle as a whole and which cannot be covered by the regenerative braking force. The brake system is configured to, in a condition in which no request for the electric braking force is made, (a) in principle, cause the piston to be located at a retracted position at which a clearance between the friction member and the rotary body is allowed to be equal to a first clearance, and (b) execute a regenerative-braking-force-dependent standby control in which the piston is moved from the retracted position to a standby position at which the clearance between the friction member and the rotary body does not exceed a second clearance that is set to be smaller than the first clearance, when a difference between a maximum regenerative braking force that can be generated and the regenerative braking force that is being actually generated becomes smaller than or equal to a set difference.

### Advantageous Effects

According to the vehicle brake system constructed as described above, the clearance is made small in consideration of the regenerative braking force when a probability of generation of the electric braking force becomes high, in other words, when it is expected that the electric braking force will be generated very soon. Thus, the vehicle brake system enables good response to be achieved in the electric brake device and the drag phenomenon to be prevented or reduced for the longest possible time.

### FORMS OF THE INVENTION

There will be exemplified and explained various forms of an invention that is considered claimable. (The invention will be hereinafter referred to as “claimable invention” where appropriate). Each of the forms is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following description of various forms and embodiments. It is to be further understood that, as long as the claimable invention is construed in this way, any form in which one or more constituent elements is/are added to or deleted from any one of the following forms may be considered as one form of the claimable invention.

(1) A brake system for a vehicle, comprising:

a regenerative brake device configured to generate a regenerative braking force utilizing electric power generation by rotation of a wheel; and

an electric brake device including a rotary body configured to rotate with the wheel, a friction member configured to be pushed onto the rotary body, and an actuator configured to advance a piston by an electric motor so as to push the friction member onto the rotary body, the electric brake device being configured to generate an electric braking force that depends on a force exerted by the electric motor,

wherein the vehicle brake system is configured such that the electric braking force covers an insufficient braking force that cannot be covered by the regenerative braking force, the insufficient braking force being a shortage in a required overall braking force which is a braking force required for the vehicle as a whole, and

wherein, in a condition in which no request for the electric braking force is made, the brake system is configured to:

(a) in principle, cause the piston to be located at a retracted position at which a clearance between the friction member and the rotary body is allowed to be equal to a first clearance; and

(b) execute a regenerative-braking-force-dependent standby control in which the piston is moved from the retracted position to a standby position at which the clearance between the friction member and the rotary body does not exceed a second clearance that is set to be smaller than the first clearance, when a difference between a maximum regenerative braking force that can be generated and the regenerative braking force that is being actually generated becomes smaller than or equal to a set difference.

This form is a basic form of the claimable invention. According to this form, the piston of the electric brake device is caused to be located at the standby position in dependence on a state of generation of the regenerative braking force. Specifically, when there is a high probability that a shortage in the braking force required for the vehicle as a whole will be caused unless the electric braking force is generated, namely, when the electric braking force is expected to be generated very soon, the piston is caused to be located at a position at which the clearance between the friction member and the rotary body is small. Conversely, when the probability of generation of the electric braking force is low, the piston is caused to be located at a position at which a large clearance is allowed to be present between the friction member and the rotary body. According to this form, execution of the regenerative-braking-force-dependent standby control enables the drag phenomenon in the electric brake device to be effectively avoided or reduced while enabling achievement of good response of the electric brake device, i.e., good response of the vehicle brake system as a whole. That is, this form enables construction of the vehicle brake system having high utility.

This form is applicable to both of a system in which the electric braking force and the regenerative braking force are given to the same wheel and a system in which the electric braking force and the regenerative braking force are given to mutually different wheels. Further, the electric braking force covers at least a part of the insufficient braking force. Specifically, in the case where the electric brake device is provided for each of a plurality of wheels, a sum of the electric braking forces generated by the respective electric brake devices may cover the insufficient braking force. Further, in a system in which the electric brake device is provided for a part of the plurality of wheels and a brake device other than the electric brake device, e.g., a hydraulic brake device, is provided for other part of the plurality of wheels, the insufficient braking force may be covered by a hydraulic braking force generated by the hydraulic brake device and the electric braking force generated by the electric brake device.

(2) The vehicle brake system according to the form (1), wherein, in a state in which the piston is located at the retracted position, the regenerative-braking-force-dependent standby control is executed based on the fact that a running speed of the vehicle is higher than or equal to a first threshold speed.

In the case where a speed of the vehicle becomes equal to a certain speed in the process of deceleration of the vehicle, it is highly probable that the brake operation member starts to be operated. In view of this, the first threshold speed is preferably set to a speed at which there is a high probability that the braking force request for the vehicle will be made when the vehicle running speed becomes lower than the speed, and the piston is preferably located at the standby position when the vehicle running speed is less than the first threshold speed, irrespective of a difference between the maximum regenerative braking force and the regenerative braking force being actually generated. This form may be considered as a form in which the condition based on the vehicle running speed is additionally included as the condition for executing the regenerative-braking-force-dependent standby control. According to this form, in the case where the vehicle running speed is higher than or equal to the first threshold speed, the regenerative-braking-force-dependent standby control is executed in principle even in the state in which the piston is located at the retracted position, so that the piston is caused to be located at the standby position when the difference between the maximum regenerative braking force and the regenerative braking force being actually generated becomes smaller than or equal to the set difference.

(3) The vehicle brake system according to the form (2), wherein, in a state in which the piston is located at the standby position, the piston is moved to the retracted position when the running speed of the vehicle becomes higher than or equal to a second threshold speed that is set to be higher than the first threshold speed.

When the preceding form is considered as a form in which the condition of changing the position of the piston from the retracted position to the standby position is limited, this form is a form in which the condition of changing the position of the piston from the standby position to the retracted position is limited. In the case where a threshold speed for changing the piston position from the retracted position to the standby position and a threshold speed for changing the piston position from the standby position to the retracted position are set to mutually the same speed in an arrangement in which the position of the piston is changed based on the vehicle running speed, there may be a possibility that the piston is controlled to be repeatedly moved between the standby position and the retracted position when the vehicle running speed is kept at around the threshold speed. That is, a hunting phenomenon in control may occur. According to this form, the first threshold speed and the second threshold speed are set to mutually different speeds, so that the hunting phenomenon is effectively prevented.

(4) The vehicle brake system according to the form (2) or (3), wherein, when the running speed of the vehicle becomes lower than or equal to a regenerative-braking prohibition speed that is set to be lower than the first threshold speed, the regenerative braking force is not generated by the regenerative brake device.

In this form, the relationship between the first threshold speed and the regenerative-braking prohibition speed is specified. In general, the regenerative brake device cannot effectively generate the regenerative braking force when the vehicle running speed becomes lower to some extent. In view of this, the regenerative-braking prohibition speed is set. The first threshold speed has a greater significance in the case where the regenerative-braking prohibition speed is set. Specifically, by setting the first threshold speed to be higher than the regenerative-braking prohibition speed as described above, the piston can be located at the standby position before the regenerative brake device cannot generate the regenerative braking force in the process of deceleration of the vehicle. Thus, the response of the electric brake device can be sufficiently achieved.

(5) The vehicle brake system according to any one of the forms (1) through (4), wherein, in a situation in which the regenerative brake device cannot generate the regenerative braking force, the piston is caused to be located at the standby position when a brake operation member is being operated or when the brake operation member is not being operated and an accelerator operation member is not being operated, even if no request for the electric braking force is made.

The regenerative brake device may fail to generate the regenerative braking force depending upon a state of charge (SOC) of a battery for accumulating a generated electric quantity, for instance. In such a situation, the maximum regenerative braking force is 0, and it is not preferable to change the piston position according to the condition described above based on the maximum regenerative braking force. In this form, the piston position is changed based on the state of the brake operation and the state of the accelerating operation. This form achieves good response of the electric braking force even in the situation in which the regenerative braking force cannot be generated.

### BRIEF DESCRIPTION OF THE DRAWINGS

The objects, features, advantages, and technical and industrial significance of the present disclosure will be better understood by reading the following detailed description of one embodiment, when considered in connection with the accompanying drawings, in which:

FIG. 1 is a view conceptually illustrating an overall structure of a vehicle brake system according to one embodiment;

FIG. 2 is a cross-sectional view of an electric brake device of the brake system illustrated in FIG. 1;

FIG. 3 is a cross-sectional view of an electric brake actuator of the electric brake device illustrated in FIG. 2;

FIGS. 4A and 4B are views for explaining a biasing mechanism of the actuator illustrated in FIG. 3;

FIG. 5 is a flowchart showing a brake control program executed in the vehicle brake system of the embodiment;

FIG. 6 is a flowchart showing a subroutine of the brake control program of FIG. 5, the subroutine being for determining a target braking force;

FIG. 7 is a time chart for explaining a typical operation of the vehicle brake system of the embodiment; and

FIG. 8 is a time chart for explaining another typical operation of the vehicle brake system of the embodiment.

### DETAILED DESCRIPTION OF THE EMBODIMENT

Referring to the drawings, there will be explained below in detail a vehicle brake system according to one embodiment of the claimable invention. It is to be understood that the claimable invention is not limited to the details of the following embodiment but may be embodied based on the forms described in Forms of the Invention and may be changed and modified based on the knowledge of those skilled in the art.

### [A] Structure of Vehicle Drive System and Overall Structure of Vehicle Brake System

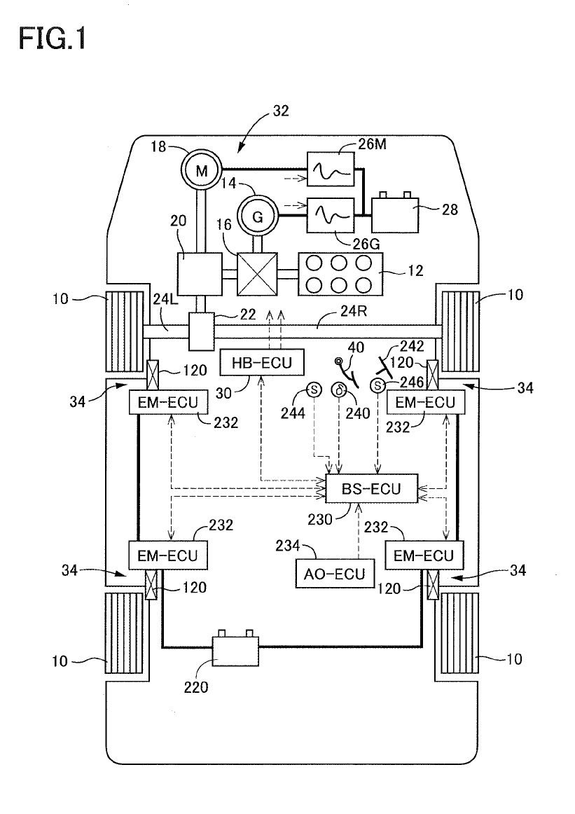

As schematically illustrated in FIG. 1, a vehicle on which is installed a vehicle brake system according to the present embodiment (hereinafter simply referred to as “brake system” where appropriate) is a hybrid vehicle having four wheels 10, namely, two front wheels 10 and two rear wheels 10. The two front wheels 10 are drive wheels. A vehicle drive system will be first explained. The vehicle drive system installed on the vehicle includes an engine 12 as a drive source, a generator 14 that functions mainly as an electric generator, a power-distribution mechanism 16 to which the engine 12 and the generator 14 are coupled, and an electric motor 18 as another drive source.

The power-distribution mechanism 16 has a function of distributing rotation of the engine 12 to rotation of the generator 14 and rotation of an output shaft. The electric motor 18 is coupled to the output shaft via a reduction mechanism 20 functioning as a speed reducer. The rotation of the output shaft is transmitted to the front right and left wheels 10 via a differential mechanism 22 and respective drive shafts 24L, 24R, so that the front right and left wheels 10 are drivingly rotated. The generator 14 is coupled to a battery 28 via an inverter 26G. Electric energy obtained by electric power generation of the generator 14 is stored in the battery 28. The electric motor 18 is coupled to the battery 28 via an inverter 26M. The electric motor 18 and the generator 14 are controlled by controlling the inverter 26M and the inverter 26G, respectively. Management of a charged amount of the battery 28 and control of the inverter 26M and the inverter 26G are executed by a hybrid electronic control unit (hereinafter abbreviated as “HB-ECU” as shown in FIG. 1) 30 that includes a computer and drive circuits (drivers) for components of the vehicle drive system.

As schematically shown in FIG. 1, the brake system according to the embodiment installed on the vehicle includes (a) a regenerative brake device 32 configured to give a braking force to each of the two front wheels 10 and (b) four electric brake devices 34 each configured to give a braking force to a corresponding one of the four wheels 10 independently of the braking force by the regenerative brake device 32. The operation of the brake system is controlled, in principle, based on an operation on a brake pedal 40, as a brake operation member, made by a driver.

### [B] Structure of Regenerative Brake Device

In terms of hardware, the regenerative brake device 32 constitutes a part of the vehicle drive system. When the vehicle decelerates, the electric motor 18 is rotated by rotation of the front wheels 10 without receiving a power supply from the battery 28. The electric motor 18 generates electric power utilizing an electromotive force generated by its rotation, and the generated electric power is stored, via the inverter 26M, in the battery 28 as a quantity of electricity (which may be also referred to as an electric quantity or an electric charge). That is, the electric motor 18 functions as an electric generator, so that the battery 28 is charged. The rotation of the front wheels 10 is decelerated, namely, the vehicle is decelerated, by a degree corresponding to energy that corresponds to the charged electric quantity. In the present vehicle, the regenerative brake device 32 is thus configured. The braking force given by the regenerative brake device 32 to the front wheels 10F (hereinafter referred to as “regenerative braking force” where appropriate) depends on the generated electric power, and the generated regenerative braking force is controlled by the control of the inverter 26M executed by the HB-ECU 30. A detailed explanation of the regenerative brake device 32 is dispensed with because any regenerative brake device having a known ordinary structure may be employed as the regenerative brake device 32.

### [C] Structure of Electric Brake Device

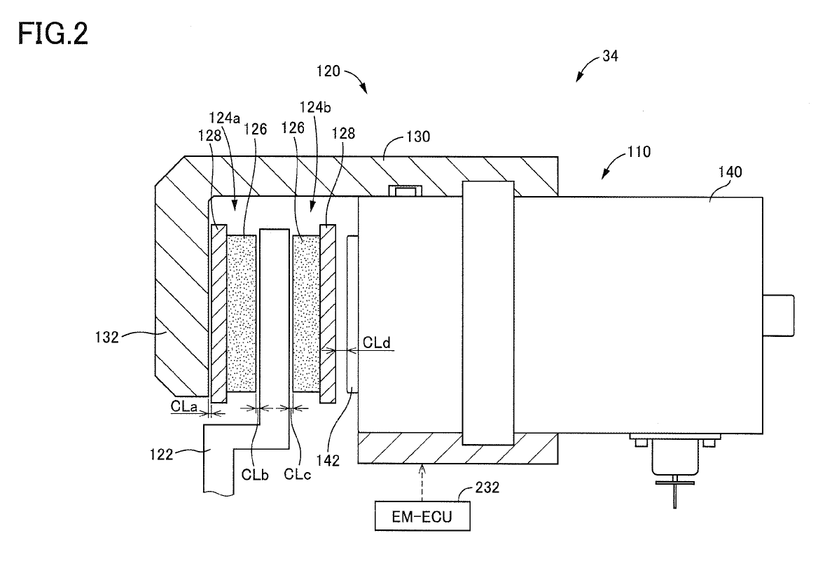

As shown in FIG. 2, each electric brake device 34 includes: a brake caliper 120 (hereinafter simply referred to as “caliper 120” where appropriate) in which an electric brake actuator 110 (hereinafter simply referred to as “actuator 110” where appropriate) is disposed as a principal constituent element; and a disc rotor 122, as a rotary body, configured to rotate together with a wheel.

### i) Structure of Brake Caliper

The caliper 120 is held by a mount (not shown) provided in a carrier (not shown) that rotatably holds the wheel, such that the caliper 120 is movable in the axial direction, i.e., the right-left direction in FIG. 1, and such that the caliper 120 straddles over the disc rotor 122. A pair of brake pads (hereinafter simply referred to as “pads” where appropriate) 124a, 124b are held by the mount so as to sandwich the disc rotor 122 therebetween in a state in which the pads 124a, 124b are movable in the axial direction. Each of the pads 124a, 124b includes a friction member 126 disposed on one side thereof on which the pad 124a, 124b comes into contact with the disc rotor 122 and a backup plate 128 supporting the friction member 126. Each of the pads 124a, 124b itself may be regarded as the friction member.

For the sake of convenience, a left side and a right side in FIG. 1 are defined as a front side and a rear side, respectively. The pad 124a located on the front side is supported by a front end portion (claw portion) 132 of a caliper main body 130. The actuator 110 is held by a rear-side portion of the caliper main body 130 such that a housing 140 of the actuator 110 is fixed to the rear-side portion of the caliper main body 130. The actuator 110 includes a piston 142 configured to advance and retract relative to the housing 140. When the piston 142 advances, a front end portion, namely, a front end, of the piston 142 comes into engagement with the rear-side pad 124b, specifically, comes into engagement with the backup plate 128 of the pad 124b. When the piston 142 further advances while being kept engaged with the backup plate 128 of the pad 124b, the pair of pads 124a, 124b sandwich or nip the disc rotor 122 therebetween. In other words, the friction members 126 of the respective pads 124a, 124b are pushed onto the disc rotor 122. Owing to the pushing of the friction members 126 of the pads 124a, 124b onto the disc rotor 122, there is generated a braking force for stopping rotation of the wheel that depends on a friction force between the disc rotor 122 and the friction members 126, namely, there is generated a braking force for reducing the speed of the vehicle or stopping the vehicle.

### ii) Structure of Actuator

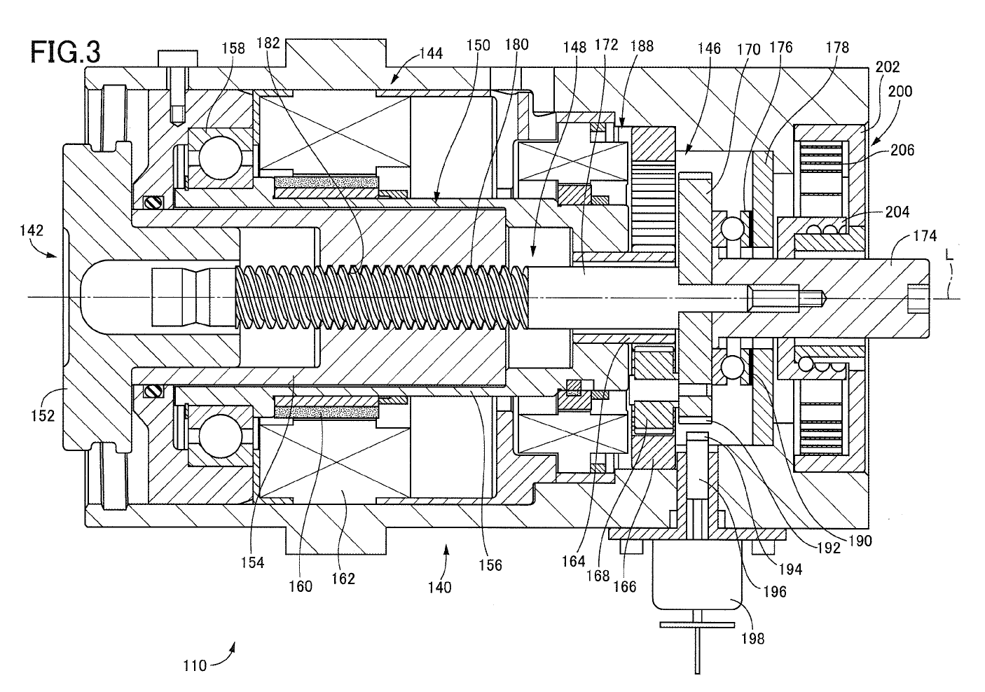

As shown in FIG. 3, the actuator 110 includes the housing 140, the piston 142, an electric motor 144 as a drive source, a speed reducer 146 for decelerating rotation of the electric motor 144, an input shaft 148 configured to be rotated by the rotation of the electric motor 144 decelerated by the speed reducer 146, and a motion converting mechanism 150 configured to convert the rotating motion of the input shaft 148, i.e., the rotating motion of the electric motor 144, into an advancing and retracting movement of the piston 142. In the following explanation, a left side and a right side in FIG. 3 will be respectively referred to as a front side and a rear side, and a leftward movement and a rightward movement of the piston 14 will be respectively referred to as an advancing movement and a retracting movement. Further, the rotation of the input shaft 148 and the electric motor 144 in a direction to advance the piston 142 will be referred to as forward rotation while the rotation of the input shaft 148 and the electric motor 144 in a direction to retract the piston 142 will be referred to as reverse rotation.

The piston 142 includes a piston head 152 and an output sleeve 154 which is a hollow cylindrical portion of the piston 142. The electric motor 144 includes a cylindrical rotary drive shaft 156. The output sleeve 154 is disposed in the rotary drive shaft 156, and the input shaft 148 is disposed in the output sleeve 154, such that the output sleeve 154, the rotary drive shaft 156, and the input shaft 148 are coaxial relative to each other, specifically, such that respective axes of the rotary drive shaft 156, the output sleeve 154, and the input shaft 148 coincide with an axis L common thereto. Thus, the actuator 110 is compact in size.

The rotary drive shaft 156 is held by the housing 140 via a radial bearing 158 so as to be rotatable and immovable in an axial direction (which is a direction of extension of the axis L and coincides with the right-left direction in FIG. 2). The electric motor 144 includes magnets 160 disposed on one circumference of an outer circumferential portion of the rotary drive shaft 156 and coils 162 fixed to an inner circumferential portion of the housing 140 so as to surround the magnets 160.

The speed reducer 146 is of a planetary gear type including a hollow sun gear 164 attached and fixed to a rear end of the rotary drive shaft 156, a ring gear 166 fixed to the housing 140, a plurality of planetary gears 168 (only one of which is illustrated in FIG. 2) engaging with both of the sun gear 164 and the ring gear 166 so as to revolve about the sun gear 164. Each of the planetary gears 168 is rotatably held by a flange 170 as a carrier. The input shaft 148 includes a front-side shaft 172 that constitutes a front-side portion of the input shaft 148 and a rear-side shaft 174 that constitutes a rear-side portion of the input shaft 148, the front-side shaft 172 and the rear-side shaft 174 being threadedly engaged with each other. The flange 170 is sandwiched between and fixed by the front-side shaft 172 and the rear-side shaft 174, whereby the flange 170 rotates together with the front-side shaft 172 and the rear-side shaft 174, namely, rotates together with the input shaft 148. The rotation of the rotary drive shaft 156, namely, the rotation of the electric motor 144, is decelerated by the speed reducer 146 and transmitted as the rotation of the input shaft 148. The input shaft 148 is held by the housing 140 via the flange 170, a thrust bearing 176, and a support plate 178, so as to be rotatable and immovable in the axial direction.

External threads 180 are formed on an outer circumferential portion of the front-side shaft 172 of the input shaft 148 while internal threads 182 which are threadedly engaged with the external threads 180 are formed in the output sleeve 154. That is, the input shaft 148 on which the external threads 180 are formed functions as a rotating member which is rotatable by the rotation of the electric motor 144 while the output sleeve 154 in which the internal threads 182 are formed functions as a linearly moving member which is advanceable and retractable for advancing and retracting the piston 142. The motion converting mechanism 150 is constituted by the input shaft 148 and the output sleeve 154. It may be considered that the linearly moving member and the piston are integral in the actuator 110.

A trapezoidal thread having relatively high strength is employed as each of the external threads 180 and the internal threads 182. There is provided, between the external threads 180 and the internal threads 182, grease as a lubricant for a smooth motion of the motion converting mechanism 150, namely, for a smooth motion of the actuator 110. The actuator 110 employs the motion converting mechanism in which the rotating member includes the external threads and the linearly moving member includes the internal threads. The actuator may employ a motion converting mechanism in which the rotating member includes the internal threads and the linearly moving member includes the external threads.

As apparent from the explanation, in the actuator 110, the rotation of the electric motor 144 causes the piston 142 to be advanced or retracted. FIG. 2 shows a state in which the piston 142 is positioned at the rearmost position in its movable range (hereinafter referred to as “set backward position” where appropriate). Specifically, when the electric motor 144 rotates forwardly from this state, the piston 142 is advanced, and, as apparent from FIG. 2, the pads 124a, 124b are pushed onto the disc rotor 122 with the front end of the piston 142 held in engagement with the pad 124b, so that the braking force is generated. In this respect, the magnitude of the braking force corresponds to an electric current supplied to the electric motor 144. Subsequently, when the electric motor 144 rotates reversely, the piston 142 is retracted, and the piston 142 and the pad 124b are accordingly disengaged from each other, so that the braking force is not generated. Finally, the piston 142 returns to the set backward position shown in FIG. 3.

In addition to the constituent components described above, the actuator 110 includes a resolver 188 for detecting a rotation angle of the electric motor 144. The resolver 188 functions as a motor rotation angle sensor. Based on a detection signal of the resolver 188, the position and the movement amount of the piston 142 in the axial direction, specifically, the rotational position of the input shaft 148, can be detected. Further, there is disposed, between the support plate 178 and the thrust bearing 176, an axial-force sensor 190 (as a load cell) for detecting a force in a thrust direction acting on the input shaft 148, namely, an axial force (axial load). The axial force corresponds to a force by which the piston 142 pushes the brake pad 124b onto the disc rotor 122. Based on a detected value of the axial-force sensor 190, it is possible to detect the braking force being generated by the electric brake device 34.

The actuator 110 further includes a mechanism configured to inhibit the rotation of the input shaft 148 for allowing the electric brake device 34 to operate as an electric parking brake. Specifically, ratchet teeth 192 are formed on an outer circumferential portion of the flange 170, and there are provided: a plunger 196 having, at its distal end, a locking pawl 194 for locking the ratchet teeth 192; and a solenoid 198 fixed to the outer circumferential portion of the housing 140 for advancing and retracting the plunger 196. In a state in which the solenoid 198 is energized to permit the plunger 196 to protrude, the electric motor 144 is rotated forwardly to advance the piston 142 for permitting the locking pawl 194 to lock the ratchet teeth 192. Thus, the piston 142 is inhibited from being retracted even when the solenoid 198 is de-energized thereafter. For cancelling the locking by the locking pawl 194, the electric motor 144 is rotated forwardly with the solenoid 198 kept de-energized.

In the case where the supply of the electric current to the electric motor 144 is cut off in a state in which the piston 142 has been advanced and the braking force is being generated, the piston 142 cannot be retracted, and the braking force is kept generated. In view of such a situation, the actuator 110 includes a mechanism for retracting the piston 142 by an elastic force of an elastic member, namely, a biasing mechanism 200 configured to give, to the input shaft 148, a rotational biasing force (which may be referred to as a “rotational torque”) in a direction in which the piston 142 is retracted.

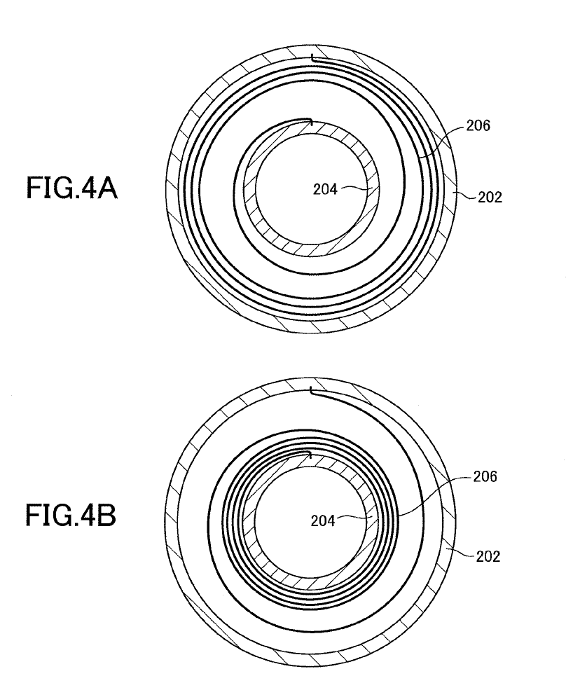

Specifically, the biasing mechanism 200 is constituted by an outer ring 202 fixed to the housing 140, an inner ring 204 fixed to the rear-side shaft 174 of the input shaft 148 so as to rotate therewith and disposed on an inner side of the outer ring 202, and a spiral spring 206, as the elastic member, disposed between an inner circumferential surface of the outer ring 202 and an outer circumferential surface of the inner ring 204. In a state of FIG. 3, namely, in a state in which the piston 142 is positioned at the set backward position indicated above, the spiral spring 206 is not substantially elastically deformed as shown in FIG. 4A, and the spiral spring 206 does not substantially generate the elastic force. Subsequently, as the input shaft 148 is rotated by the electric motor 144 and the piston 142 is accordingly advanced, the spiral spring 206 is gradually wound and contracted as shown in FIG. 4B, so as to generate the elastic force. That is, the elastic force whose magnitude corresponds to an amount of the advancing movement of the piston 142 that has been advanced from the set backward position acts on the input shaft 148 as a biasing force against the advancing movement of the piston 142, namely, as a biasing force in a direction in which the piston 142 is retracted. In other words, the biasing force that acts on the input shaft 148 by the spiral spring 206 increases as the piston 142 is advanced further. The rotational biasing force enables the piston 142 to be retracted even in the case where the piston 142 cannot be retracted by the electric motor 144 in the state in which the piston 142 has been advanced and the braking force is being generated.

In the motion converting mechanism 150 described above, the negative (reverse) efficiency (that is efficiency when the input shaft 148 is rotated by the advancing and retracting movement of the piston 142) is smaller than the positive (forward) efficiency (that is efficiency when the piston 142 is advanced and retracted by the rotation of the input shaft 148) while a lead angle of each of the external threads 180 and the internal threads 182 is relatively large. Thus, the motion converting mechanism 150 has a certain degree of the negative (reverse) efficiency. For permitting the piston 142 to be kept located at an intermediate position in its movable range, there is supplied, to the electric motor 144, an electric current large enough to enable the electric motor 144 to generate a force against the biasing force by the biasing mechanism 200.

In the thus constructed system, the electric brake device 34 generates, utilizing the friction force, a braking force to stop the rotation of the wheel 10, namely, a braking force to brake the vehicle (hereinafter referred to as “electric braking force” where appropriate). As shown in FIG. 1, there is supplied, to the electric motor 144 of each of the four electric brake devices 34, an electric current from an auxiliary battery 220 different from the battery 28.

### [D] Basic Control of Vehicle Brake System

### i) Control System

Control of the brake system, namely, control of a braking force F, is executed by a control system shown in FIG. 1. (Hereinafter, respective braking forces are collectively referred to as “braking force F” where appropriate.) Specifically, the control system includes, as a main controller, a brake system electronic control unit (hereinafter abbreviated as “BS-ECU” where appropriate) 230 that is mainly constituted by a computer. Under control of the BS-ECU 230, each electric brake device 34 is controlled by an electronic control unit for the electric brake device (hereinafter abbreviated as “EM-ECU” where appropriate) 232 which is a constituent element of a corresponding one of the electric brake devices 34. Each EM-ECU 232 functions as a controller in the corresponding electric brake device 34 and is constituted by a computer, drivers (drive circuits) for components of the electric brake device 34, inverters, and so on. The regenerative brake device 32 is controlled by the HB-ECU 30 under control of the BS-ECU 230 as explained above. In the control system, the BS-ECU 230 functions as a main controller configured to control the HB-ECU 30 and the EM-ECUs 232.

More specifically, the HB-ECU 30 controls the inverters 26G, 26M that constitute the regenerative brake device 32 so as to control the regenerative braking forces F_{RG} for the respective front wheels 10, and the EM-ECUs 232 control the electric motors 144 of the corresponding electric brake devices 34, so as to control the electric braking forces F_{EM} for the respective four wheels 10. Thus, an overall braking force F_{SUM}, which is the braking force F to be given to the vehicle as a whole, is controlled. In the vehicle brake system, the HB-ECU 30, the BS-ECU 230, and the EM-ECUs 232 are connected to one another by a network in the vehicle (CAN) and execute the respective controls while performing communication with one another.

The vehicle on which the brake system is installed is capable of executing automated or autonomous driving following a preceding vehicle which is running ahead of own vehicle or capable of avoiding a collision of the own vehicle. That is, the vehicle includes an automatic driving operation system that enables an automatic driving operation of the vehicle (which may be also referred to as “automated or autonomous driving” or “self-driving”). There is installed, on the vehicle, an electronic control unit for the vehicle automatic driving operation (hereinafter referred to as “AO-ECU” where appropriate) 234 as the core of the automatic driving operation system. The AO-ECU 234 executes the automatic driving operation of the vehicle based on information from a surroundings monitoring system (which may be considered as a part of the automatic driving operation system) installed on the vehicle. In the automatic driving operation, a brake request not based on an intention of the driver, namely, a request for the automatic brake, is made when a distance between the own vehicle and the preceding vehicle is shortened or when a possibility of collision with an obstacle becomes high. The request is transmitted from the AO-ECU 234 to the BS-ECU 230 as a signal as to the overall braking force F_{SUM} to be required (which will be later explained). It may be considered that a controller of the brake system is constituted by the HB-ECU 30, the BS-ECU 230, the EM-ECUs 232, and the AO-ECU 234 and that a part of the controller functions as the controllers of the respective electric brake devices 34.

### ii) Basic Control of Braking Force

Basic control of the braking force in the brake system (hereinafter simply referred to as “braking-force control” where appropriate) is executed in the following manner. A braking force request intended by the driver is obtained based on a brake operation amount δ indicative of the request. As shown in FIG. 1, the brake system includes a stroke sensor 240 configured to detect a stroke amount of the brake pedal 40 as a brake operation amount S. Based on the detected brake operation amount δ, there is determined a braking force request by the driver for the vehicle as a whole, namely, a required overall braking force F_{SUM}* which is the braking force F required for the vehicle as a whole (i.e., a sum of the braking forces F to be given to the respective four wheels 10). It is noted that an operation force applied to the brake pedal 40 by the driver, namely, a brake operation force, may be used as an index indicative of the braking force request.

In the case where the automatic brake is necessary, the AO-ECU 234 determines the required overall braking force F_{SUM}*, and information as to the determined required overall braking force F_{SUM}* is transmitted from the AO-ECU 234 to the BS-ECU 230. In this case, the BS-ECU 230 executes the braking-force control based on the required overall braking force F_{SUM}* based on the received information.

In the vehicle brake system, the regenerative braking force F_{RG} is generated with a higher priority, and the electric braking forces F_{EM} generated by the respective electric brake devices 34 cover a shortage in the required overall braking force F_{SUM}* that cannot be covered by the regenerative braking force F_{RG}. The shortage will be hereinafter referred to as an insufficient braking force F_{IS}. For simplifying the explanation, the regenerative braking force F_{RG} is regarded as a sum of the braking forces F to be given to the respective front wheels 10 by the regenerative brake device 32. Further, the electric braking force F_{EM} is regarded as the braking force to be given to each of the four wheels 10 by a corresponding one of the electric brake devices 34, and a sum of the electric braking forces F_{EM} to be given to the respective four wheels 10 (which will be hereinafter referred to as “four electric braking forces F_{EM}” where appropriate) is given to the vehicle as a whole. Further, the insufficient braking force F_{IS} is distributed evenly to the four wheels 10, and the four electric braking forces F_{EM} are mutually equal.

The HB-ECU 30 transmits, to the BS-ECU 230, a signal as to a maximum regenerative braking force F_{RG-MAX} which is the regenerative braking force F_{RG} that can be generated at that time. The maximum regenerative braking force F_{RG-MAX} is determined by the HB-ECU 30 based on the degree of the charge amount (remaining charge amount) of the auxiliary battery 220 at that time, the running speed of the vehicle (vehicle running speed) v, and so on. Specifically, in the case where the auxiliary battery 220 is in a fully charged state, the regenerative brake device 32 cannot generate the regenerative braking force F_{RG}, and the maximum regenerative braking force F_{RG-MAX} is accordingly made equal to 0. In the case where the vehicle running speed v becomes low to a certain extent, it is difficult to generate an effective regenerative braking force. Accordingly, also in the case where the vehicle running speed v becomes lower than or equal to the regenerative-braking prohibition speed v_{RG}, the maximum regenerative braking force F_{RG-MAX} is made equal to 0. In this respect, the vehicle running speed v is identified based on detected values of wheel speed sensors (not shown) provided for the respective wheels 10.

The BS-ECU 230 determines, as a target regenerative braking force F_{RG}*, the regenerative braking force F_{RG} that is maximum within a range not exceeding both of the required overall braking force F_{SUM}* and the maximum regenerative braking force F_{RG-MAX}, based on the maximum regenerative braking force F_{RG-MAX} transmitted as the signal and the required overall braking force F_{SUM}* described above. Subsequently, the BS-ECU 230 determines the insufficient braking force F_{IS} by subtracting the target regenerative braking force F_{RG}* from the required overall braking force F_{SUM}*. To cover the insufficient braking force F_{IS} by the four electric braking forces F_{EM}, the BS-ECU 230 determines a target electric braking force F_{EM}* as the electric braking force F_{EM} to be generated by each electric brake device 34. A signal as to the target regenerative braking force F_{RG}* and a signal as to the target electric braking force F_{EM}* are transmitted from the BS-ECU 230 respectively to the HB-ECU 30 and each EM-ECU232.

The regenerative brake device 32 and the four electric brake devices 34 are controlled based on the target regenerative braking force F_{RG}* and the target electric braking force F_{EM}*, respectively. Specifically, the HB-ECU 30 controls the inverter 26M such that the regenerative braking force F_{RG} becomes equal to the target regenerative braking force F_{RG}*. The EM-ECU 232 of each of the four electric brake devices 34 controls a supply current I supplied to the electric motor 144 of the corresponding electric brake device 34 such that the electric braking force F_{EM} for the corresponding wheel 10 becomes equal to the target electric braking force F_{EM}*. As for the electric braking force F_{EM}, the electric current supplied to the electric motor 144 is feedback controlled such that an axial force (thrust load) W_{S} detected by the axial-force sensor 190 is equal to a target axial force W_{S}* determined based on the target electric braking force F_{EM}*. Hereinafter, this control relating to the electric brake devices 34 will be hereinafter referred to as an axial-force feedback control (axial-force FB control) where appropriate.

### [E] Control of Electric Brake Device in Non-Request Condition of Electric Braking Force

### i) Response of Electric Brake Device and Drag Phenomenon

Any type of the brake device inevitably experiences some time lag between a time point when the braking force request is made and a time point when the braking force is actually generated. The shorter the time lag, the better the response. On the other hand, the electric brake device 34 may suffer from what is called drag phenomenon when no request for the electric braking force F_{EM} is being made, namely, in a non-request condition of the electric braking force F_{EM}. The drag phenomenon is a phenomenon in which the vehicle runs with the friction members 126 of the brake pads 124a, 124b pressed onto the disc rotor 122. The drag phenomenon is a cause of a deterioration in the fuel economy of the vehicle.

In the electric brake device 34, the piston 142, namely, the output sleeve 154 as the linearly moving member, is positioned such that a certain size of a clearance CL is formed between the friction member 126 and the disc rotor 122 when no request for the electric braking force F_{EM} is being made. The clearance CL is considered as a total of the following four clearances shown in FIG. 2, i.e., a clearance CLa between the front end portion 132 of the caliper main body 130 and the backup plate 128 of the brake pad 124a, a clearance CLb between the friction member 126 of the brake pad 124a and the disc rotor 122, a clearance CLc between the disc rotor 122 and the friction member 126 of the brake pad 124b, and a clearance CLd between the backup plate 128 of the brake pad 124b and the piston 142. In FIG. 2, the clearances CLa-CLd are exaggeratedly illustrated.

### ii) Control of Piston Position in Electric Brake Device

The clearance CL is desirably as small as possible in view of the response while the clearance CL is desirably somewhat large in view of avoidance or a reduction of the drag phenomenon. In the brake system, therefore, in the condition in which no request for the electric braking force F_{EM} is made (i.e., in the non-request condition for the electric braking force F_{EM}), the piston 142 of the electric brake device 34 is caused to be located at a “retracted position P_{B}” in principle, so as to permit the clearance CL to be equal to a first clearance CL1 which is set to be relatively large to such an extent that the drag phenomenon does not substantially occur. When the probability that the request for the electric braking force F_{EM} will be made becomes high to a certain extent, in other words, when it is expected that the electric braking force F_{EM} will be generated very soon, the piston 142 is caused to be located at a “standby position P_{S}” at which the clearance CL does not exceed a second clearance CL2 that is set to be smaller than the first clearance CL1. In short, when the predetermined condition is satisfied, the piston 142 is advanced such that the position of the piston 142 (hereinafter referred to as “piston position P” where appropriate) is changed from the retracted position P_{B} to the standby position P_{S}. When the probability that the request for the electric braking force F_{EM} will be made becomes low to a certain extent, the piston 142 is retracted such that the piston position P is changed from the standby position P_{S} to the retracted position P_{B}.

The control of the position of the piston 142, in a strict sense, the control of the position of the output sleeve 154, is executed by the EM-ECU 232 based on the detected value of the resolver 188 of the actuator 110. While not explained in detail, the EM-ECU 232 constantly grasps the piston position P at a time point when the axial force W_{S} detected by the axial-force sensor 190 is generated, namely, the piston position P at a time point when the clearance CL becomes 0, in the case where the piston 142 is advanced. Based on the position, the EM-ECU 232 sets a position at which the clearance CL is equal to the first clearance CL1 as the retracted position P_{B} and sets a position at which the clearance CL is equal to the second clearance CL2 as the standby position P_{S}. Further, the EM-ECU 232 determines a target piston position P*(as a target position in the control of the piston position P) to be one of the retracted position P_{B} and the standby position P_{S}, and feedback controls the supply current to the electric motor 144 such that the piston position P reaches the target piston position P* or the piston position P is maintained at the target piston position P. Hereinafter, this control relating to the electric brake device 34 will be referred to as a piston-position feedback control (the piston-position FB control) where appropriate.

In the piston-position feedback control, the control for causing the piston 142 to be located at the retracted position P_{B}, namely, the control for moving the piston 142 to the retracted position P_{B} or maintaining the piston 142 at the retracted position P_{B}, is referred to as a retracting control while the control for causing the piston 142 to be located at the standby position P_{S}, namely, the control for moving the piston 142 to the standby position P_{S} or maintaining the piston 142 at the standby position P_{S}, is referred to as a standby control. As explained above, the retracting control is executed in principle when no request for the electric braking force F_{EM} is being made, and the standby control is executed when the probability that the request for the electric braking force F_{EM} will be made becomes high to a certain extent, namely, when the predetermined condition is satisfied.

iii) Concrete Conditions for Executing Standby Control and Retracting Control

The standby control is executed based on the vehicle running speed v. Specifically, the standby control is executed in consideration of an increase in the probability that the request for the braking force with respect to the vehicle will be made when the vehicle running speed v becomes equal to a certain speed in the process of deceleration of the vehicle. More specifically, the standby control is executed when the vehicle running speed v is lower than a first threshold speed v₁ as a set threshold speed v_{TH} in consideration of an increase in the probability that the request for generation of the braking force F with respect to the vehicle will be made, namely, in consideration of an increase in the probability that the request for generation of the overall braking force F_{SUM} will be made. When the vehicle running speed v becomes higher than or equal to a second threshold speed v₂ as a set threshold speed v_{TH} in a state in which the piston 142 is located at the standby position P_{S} by the standby control, the retracting control is executed in consideration of a decrease in the probability that the request for generation of the overall braking force F_{SUM} will be made. The second threshold speed v₂ is set to be higher than the first threshold speed v₁ to prevent hunting that will occur in switching between the standby control and the retracting control. As explained above, when the vehicle running speed v becomes lower than or equal to the regenerative-braking prohibition speed v_{RG}, the regenerative braking force F_{RG} cannot be generated. Thus, the first threshold speed v₁ and the second threshold speed v₂ are set to be higher than the regenerative-braking prohibition speed v_{RG}. In the following explanation, the first threshold speed v₁ when the piston 142 is located at the retracted position P_{B} and the second threshold speed v₂ when the piston 142 is located at the standby position P_{S} will be collectively referred to as the threshold speed v_{TH} where appropriate.

In a situation in which the regenerative braking force F_{RG} cannot be generated even when the vehicle running speed v is higher than or equal to the threshold speed v_{TH}, namely, in a situation in which the maximum regenerative braking force F_{RG-MAX} is 0, it is determined which one of the standby control and the retracting control is to be executed based on operating states of the brake pedal 40 and an accelerator pedal 242 (FIG. 1) as an accelerator operating member. The operating states of the brake pedal 40 and the accelerator pedal 242 are determined based on pedal sensors 244, 246 respectively provided for the brake pedal 40 and the accelerator pedal 242. The pedal sensor 244 detects that the brake pedal 40 is being operated if the driver even lightly rests his/her foot on the brake pedal 40, and the pedal sensor 246 detects that the accelerator pedal 242 is being operated if the driver even lightly rests his/her foot on the accelerator pedal 242. As for the brake pedal 40, it is accordingly determined that the brake pedal 40 is being operated even if the brake operation amount δ is not detected by the stroke sensor 240. When the brake pedal 40 is being operated or when the brake pedal 40 is not being operated and the accelerator pedal 242 is not being operated, the standby control is executed based on a determination that the probability that the request for generation of the overall braking force F_{SUM} will be made is high. When the brake pedal 40 is not being operated and the accelerator pedal 242 is being operated, the retracting control is executed based on a determination that the probability that the request for generation of the overall braking force F_{SUM} will be made is low. In general, the brake pedal 40 and the accelerator pedal 242 are not operated at the same time. In short, when the accelerating operation is being made, the piston 142 is located at the retracted position P_{B}. When the accelerating operation is not being made, the piston 142 is located at the standby position P_{S}. In the brake system not equipped with the regenerative brake device, it is generally determined which one of the standby control and the retracting control is to be executed based on the operating states of the brake pedal and the accelerator pedal as explained above.

Even in a situation in which the vehicle running speed v is higher than or equal to the threshold speed v_{TH} and the regenerative braking force F_{RG} can be generated, the following regenerative-braking-force-dependent standby control is executed, so that the piston 142 is caused to be located at the standby position P_{S}. Here, a difference between the maximum regenerative braking force F_{RG-MAX} and the regenerative braking force F_{RG} that is actually being generated (hereinafter referred to as “actual regenerative braking force F_{RG}” where appropriate) is referred to as a regenerative braking force difference ΔF_{RG} (=F_{RG-MAX}−F_{RG}). When the regenerative braking force difference ΔF_{RG} becomes smaller than or equal to a set difference ΔF_{RG0}, the regenerative-braking-force-dependent standby control is executed based on a determination that the probability that the request for generation of the electric braking force F_{EM} will be made is high. That is, when the vehicle running speed v is less than the threshold speed v_{TH}, the standby control is executed as described above. The regenerative-braking-force-dependent standby control is executed in a situation in which the vehicle running speed v is higher than or equal to the threshold speed v_{TH} in consideration of the generation state of the regenerative braking force F_{RG}. In other words, the regenerative-braking-force-dependent standby control is executed based on the fact that the vehicle running speed v is higher than or equal to the threshold speed v_{TH}. In a state in which the piston 142 is located at the standby position by the regenerative-braking-force-dependent standby control, the piston 142 is caused to be located at the retracted position P_{B} when the regenerative braking force difference ΔF_{RG} becomes larger than the set difference ΔF_{RG0}. In determining whether the regenerative-braking-force-dependent standby control is to be executed or not, the actual regenerative braking force F_{RG} and the target regenerative braking force F_{RG}* may be regarded as being equal to each other, and a difference (F_{RG-MAX}−F_{RG}*) between the maximum regenerative braking force F_{RG-MAX} and the target regenerative braking force F_{RG}* may be used as the regenerative braking force difference ΔF_{RG}. In the brake system, the electric braking force F_{EM} is not generated in a situation in which the vehicle running speed v is higher than the regenerative-braking prohibition speed v_{RG} as long as the required overall braking force F_{SUM}* does not exceed the maximum regenerative braking force F_{RG-MAX}. Accordingly, a difference (F_{RG-MAX}−F_{SUM}*) between the maximum regenerative braking force F_{RG-MAX} and the required overall braking force F_{SUM}* may be used as the regenerative braking force difference ΔF_{RG}.

### [F] Control Flow

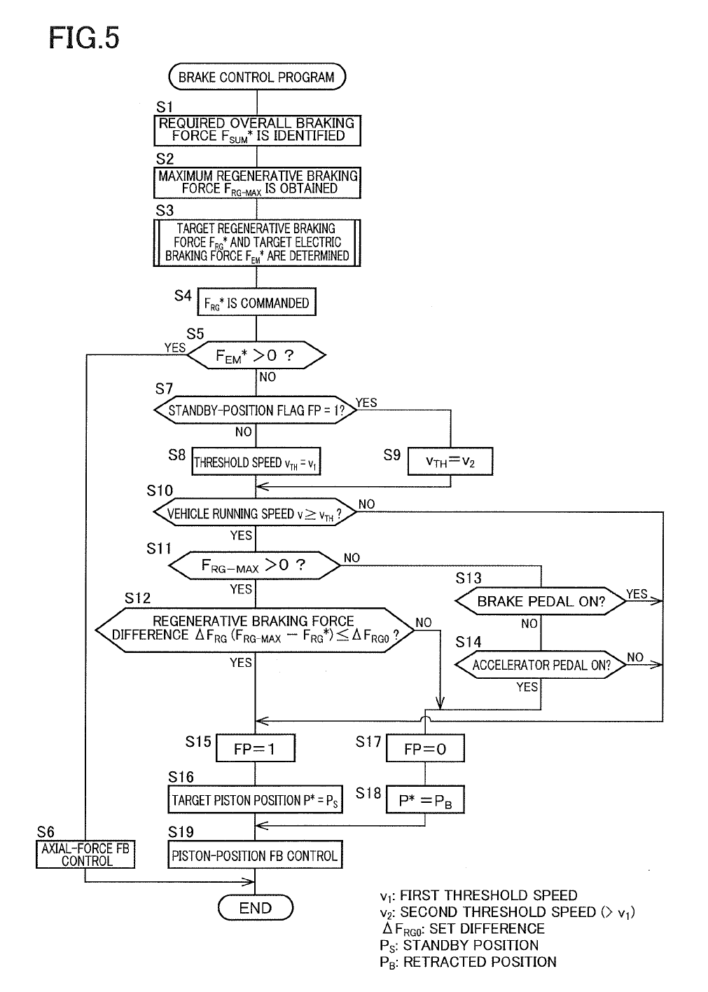

The control of the braking force F and the position control of the piston 142 of the actuator 110 of the electric brake device 34 in the non-request condition of the electric braking force F_{EM} are executed such that the BS-ECU 230 repeatedly executes a brake control program indicated by a flowchart of FIG. 5 at a short time pitch, e.g., from several to several tens of milliseconds (msec). There will be briefly explained a control flow referring to the flowchart.

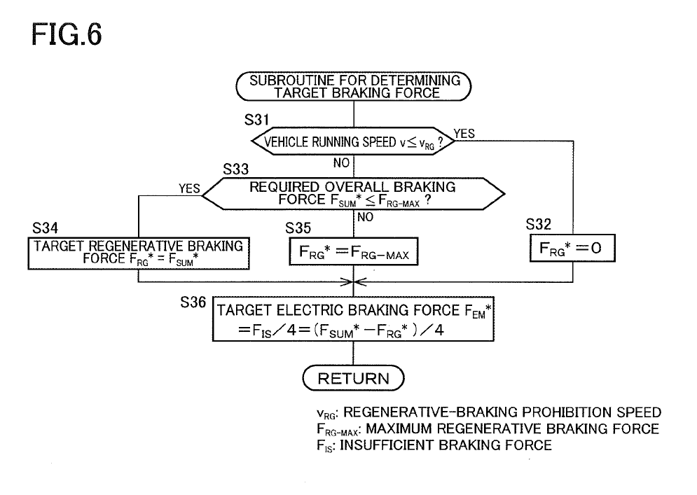

In the control process according to the brake control program, Step 1 is implemented to identify the required overall braking force F_{SUM}* based on the brake operation amount δ of the brake pedal 40 or the signal as to the required overall braking force F_{SUM}* transmitted from the AO-ECU 234. (Hereinafter, Step 1 is abbreviated as “S1”. Other Steps are similarly abbreviated.) At S2, the maximum regenerative braking force F_{RG-MAX}, which is the regenerative braking force F_{RG} that can be generated at that time, is obtained based on the signal sent from the HB-ECU 30. At S3, a subroutine for determining the target braking force indicated by a flowchart of FIG. 6 is executed to determine the target regenerative braking force F_{RG}* and the target electric braking force F_{EM}.

In the control process according to the subroutine, S31 is initially implemented to determine whether or not the vehicle running speed v is lower than or equal to the regenerative-braking prohibition speed v_{RG}. When the vehicle running speed v is lower than or equal to the regenerative-braking prohibition speed v_{RG}, the target regenerative braking force F_{RG}* is determined to be equal to 0 at S32. When the vehicle running speed v is higher than the regenerative-braking prohibition speed v_{RG}, it is determined at S33 whether or not the required overall braking force F_{SUM}* is smaller than or equal to the maximum regenerative braking force F_{RG-MAX}. When the required overall braking force F_{SUM}* is smaller than or equal to the maximum regenerative braking force F_{RG-MAX}, the target regenerative braking force F_{RG}* is determined to be equal to the required overall braking force F_{SUM}* at S34. When the required overall braking force F_{SUM}* is larger than the maximum regenerative braking force F_{RG-MAX}, the target regenerative braking force F_{RG}* is determined to be equal to the maximum regenerative braking force F_{RG-MAX} at S35. At S36, the insufficient braking force F_{IS} is determined by subtracting the determined target regenerative braking force F_{RG}* from the required overall braking force F_{SUM}*, and the insufficient braking force F_{IS} is divided by the number of the electric brake devices 34, namely, by four, so as to determine the target electric braking force F_{EM}* for each brake device 34.

At S4, the signal as to the determined target regenerative braking force F_{RG}* is transmitted to the HB-ECU 30. The HB-ECU 30 causes the regenerative brake device 32 to generate the regenerative braking force F_{RG} based on the target regenerative braking force F_{RG}*. At S5, it is determined whether the determined target electric braking force F_{EM}* is larger than 0, namely, it is determined whether the request for the electric braking force F_{EM} is being made. When the request for the electric braking force F_{EM} is being made, S6 is implemented to transmit the signal as to the target electric braking force F_{EM}* to the EM-ECUs 232 of the respective electric brake devices 34, and each EM-ECU 232 executes, for the corresponding electric brake device 34, the axial-force feedback control described above based on the target electric braking force F_{EM}*. Thus, each electric brake device 34 generates the electric braking force F_{EM} based on the target electric braking force F_{EM}*.

When no request for the electric braking force F_{EM} is being made, S7 is implemented to confirm a flag value of a standby-position flag FP. The standby-position flag FP is configured as follows. The flag value of the standby-position flag FP is “1” when the piston 142 of the actuator 110 of each electric brake device 34 is located at the standby position or when the piston 142 is caused to be located at the standby position. The flag value of the standby-position flag FP is “0” when the piston 142 is located at the retracted position or when the piston 142 is caused to be located at the retracted position. That is, the flag value of the standby-position flag FP is “1” when the standby control is being executed and is “0” when the retracting control is being executed. When the retracting control is being executed, the threshold speed v_{TH}, i.e., a speed as a basis for selecting one of the standby control and the retracting control based on the vehicle running speed v, is determined to be equal to the first threshold speed v₁ set to be higher than the regenerative-braking prohibition speed v_{RG}, at S8. When the standby control is being executed, the threshold speed v_{TH} is determined to be equal to the second threshold speed v₂ set to be higher than the first threshold speed v₁, at S9.

At S10, it is determined whether or not the vehicle running speed v is higher than or equal to the determined threshold speed v_{TH}. When the vehicle running speed v is lower than the threshold speed v_{TH}, the standby control is executed. Specifically, the flag value of the standby-position flag FP is set to “1” at S15. S16 is implemented to determine the standby position P_{S} as the target piston position P* for permitting the clearance CL to be equal to the second clearance CL2 which is relatively small. At S19, the piston-position feedback control is executed based on the determined target piston position P.

When the vehicle running speed v is higher than or equal to the threshold speed v_{TH}, it is determined at S11 whether or not the maximum regenerative braking force F_{RG-MAX} is larger than 0, namely, whether or not the regenerative braking force F_{RG} can be generated by the regenerative brake device 32. When the regenerative braking force F_{RG} can be generated, it is determined at S12 whether or not the regenerative braking force difference ΔF_{RG} is smaller than or equal to the set difference ΔF_{RG0}. The regenerative braking force difference ΔF_{RG} is a difference between the maximum regenerative braking force F_{RG-MAX} and the target regenerative braking force F_{RG}* which may be regarded as the regenerative braking force F_{RG} to be generated. When the regenerative braking force difference ΔF_{RG} is smaller than or equal to the set difference ΔF_{RG0}, the standby control is executed. Specifically, the flag value of the standby-position flag FP is set to “1” at S15, the standby position P_{S} is determined as the target piston position P* at S16, and the piston-position feedback control is executed at S19 based on the determined target piston position P*. On the other hand, when the regenerative braking force difference ΔF_{RG} is larger than the set difference ΔF_{RG0}, the retracting control is executed. Specifically, the flag value of the standby-position flag FP is set to “0” at S17, the retracted position P_{B} is determined as the target piston position P* at S18 so as to permit the clearance CL to be equal to the first clearance CL1 which is relatively large, and the piston-position feedback control is executed at S19 based on the determined target piston position P.

When it is determined at S11 that the regenerative braking force F_{RG} cannot be generated, the standby control is executed in the case where the brake operation is being performed and in the case where the brake operation is not being performed and the accelerating operation is not being performed, based on determinations at S13 and S14. In this case, the piston 142 is caused to be located at the standby position P_{S}. In the case where the accelerating operation is being performed, the retracting control is executed, so that the piston 142 is caused to be located at the retracted position P_{B}.

In the process according to the brake control program, the regenerative-braking-force-dependent standby control is executed by the processes at S15, S16, S19 executed via the determination at S11 and the determination at S12.

### [G] Typical Examples and Advantages of Vehicle Brake System

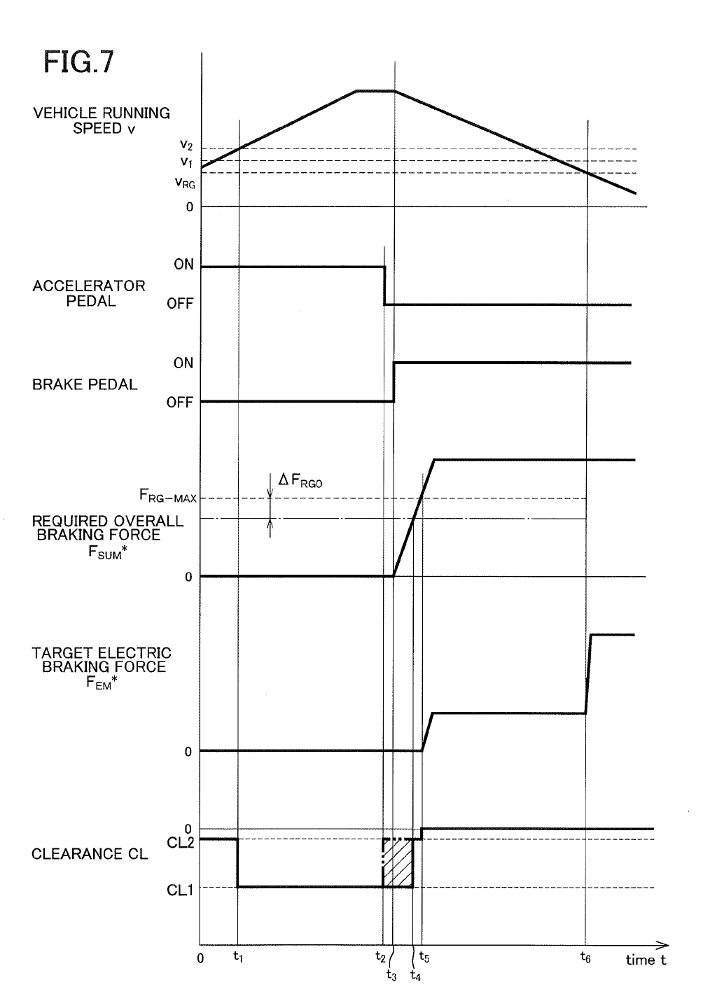

A time chart of FIG. 7 shows a typical example of the operation of the brake system according to the present embodiment when the control of the braking force F described above and the control of the electric brake device 34 in the non-request condition of the electric braking force F_{BM} are executed, especially, the operation of the brake system when the regenerative-braking-force-dependent standby control described above is executed. The time chart of FIG. 7 shows the vehicle running speed v, the operations of the accelerator pedal 242 and the brake pedal 40, changes in the required overall braking force F_{SUM}* and the target electric braking force F_{EM}*, and a change in the clearance CL in each electric brake device 34, with a lapse of time t.

The retracting control is started at a time point t₁ at which the vehicle running speed v that has increased by the operation of the accelerator pedal 242 from a speed between the regenerative-braking prohibition speed v_{RG} and the first threshold speed v₁ becomes higher than or equal to the second threshold speed v₂, so that the piston 142 is located at the retracted position and the clearance CL becomes equal to the clearance CL1. The accelerating operation is ended at a time point t₂. When the brake pedal 40 is operated at a time point t₃, the required overall braking force F_{SUM}* increases. At a time point t₄ at which the difference between the maximum regenerative braking force F_{RG-MAX} and the required overall braking force F_{SUM}* becomes equal to the set difference ΔF_{RG0}, the regenerative-braking-force-dependent standby control is started, so that the piston 142 is caused to be located at the standby position and the clearance CL becomes equal to the clearance CL2. Soon after the time point t₄, the required overall braking force F_{SUM}* exceeds the maximum regenerative braking force F_{RG-MAX} at a time point t₅, and the electric braking force F_{EM} is generated at the time point t₅. The vehicle is decelerated thereafter, and the vehicle running speed v reaches the regenerative-braking prohibition speed v_{RG} at a time point t₆. At the time point t₆, the regenerative braking force F_{RG} becomes equal to 0, and the electric braking force F_{EM} is increased by an amount corresponding to the regenerative braking force F_{RG} that has been generated before becoming to 0.

As apparent from the operation described above, the piston 142 is moved from the retracted position to the standby position by the regenerative-braking-force-dependent standby control slightly before the electric braking force is generated. Thus, the response of the electric brake device 34 is adequately ensured. In an ordinary technique, the piston 142 is moved from the retracted position to the standby position at the time point t₂, namely, at a time point when the accelerating operation is ended, as indicated by the long dashed double-short dashed line in FIG. 7. As compared with such an ordinary technique, in the present brake system, the piston 142 is kept located at the retracted position additionally for a length of time corresponding to a length of time between the time point t₂ and the time point t₄, namely, a length of time indicated as an hatched area in the time chart of FIG. 7. It is thus possible to positively avoid or reduce the drag phenomenon explained above in the electric brake device 34.

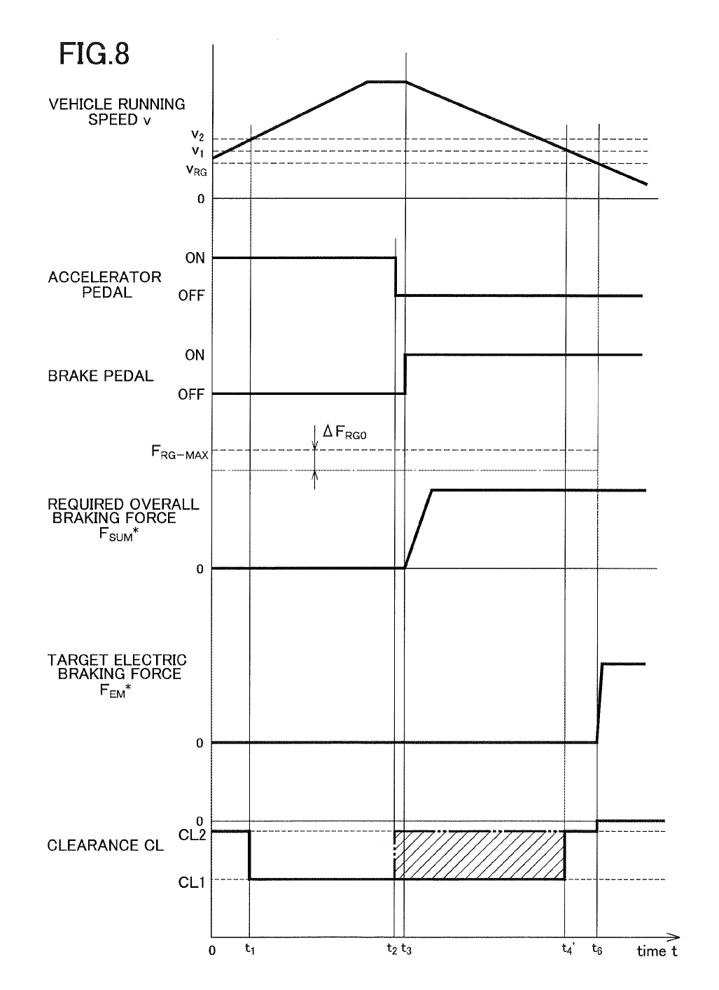

In an ordinary brake operation, the required overall braking force F_{SUM}* can be often covered only by the regenerative braking force F_{RG}. In such a case, the brake system operates as indicated in a time chart of FIG. 8. A typical example shown in the time chart of FIG. 8 indicates the operation of the brake system when the required overall braking force F_{SUM}* is sufficiently small relative to the maximum regenerative braking force F_{RG-MAX}. In this case, the standby control is started at a time point t₄′ when the vehicle running speed v becomes equal to the first threshold speed v₁, so that the piston 142 is caused to be located at the standby position and the clearance CL becomes equal to the clearance CL2. Thus, the piston 142 is kept located at the retracted position for a longer time as compared with the ordinary technique while the response of the electric brake device 34 is ensured, making it possible to avoid or reduce the drag phenomenon more positively.

While not illustrated explicitly in the time charts of FIGS. 7 and 8, the piston 142 is caused to be located at the retracted position by the retracting control, based on the fact that the difference between the maximum regenerative braking force F_{RG-MAX} and the required overall braking force F_{SUM}* is larger than the set difference ΔF_{RG0}, in the case where the vehicle running speed v becomes higher than or equal to the second threshold speed v₂ in a situation in which the request for the required overall braking force F_{SUM}* is being made and the piston 142 is located at the standby position.

What is claimed is:

1. A brake system for a vehicle, comprising:
a regenerative brake device configured to generate a regenerative braking force utilizing electric power generation by rotation of a wheel; and
an electric brake device including a rotary body configured to rotate with the wheel, a friction member configured to be pushed onto the rotary body, and an actuator configured to advance a piston by an electric motor so as to push the friction member onto the rotary body, the electric brake device being configured to generate an electric braking force that depends on a force exerted by the electric motor,
wherein the vehicle brake system is configured such that the electric braking force covers an insufficient braking force that cannot be covered by the regenerative braking force, the insufficient braking force being a shortage in a required overall braking force which is a braking force required for the vehicle as a whole, and
wherein, in a condition in which no request for the electric braking force is made, the brake system is configured to:
(a) in principle, cause the piston to be located at a retracted position at which a clearance between the friction member and the rotary body is allowed to be equal to a first clearance; and
(b) execute a regenerative-braking-force-dependent standby control in which the piston is moved from the retracted position to a standby position at which the clearance between the friction member and the rotary body does not exceed a second clearance that is set to be smaller than the first clearance, when a difference between a maximum regenerative braking force that can be generated and the regenerative braking force that is being actually generated becomes smaller than or equal to a set difference.

2. The brake system according to claim 1, wherein, in a state in which the piston is located at the retracted position, the regenerative-braking-force-dependent standby control is executed based on the fact that a running speed of the vehicle is higher than or equal to a first threshold speed.

3. The brake system according to claim 2, wherein, in a state in which the piston is located at the standby position, the piston is moved to the retracted position when the running speed of the vehicle becomes higher than or equal to a second threshold speed that is set to be higher than the first threshold speed.

4. The vehicle brake system according to claim 2, wherein, when the running speed of the vehicle becomes lower than or equal to a regenerative-braking prohibition speed that is set to be lower than the first threshold speed, the regenerative braking force is not generated by the regenerative brake device.

5. The brake system according to claim 1, wherein, in a situation in which the regenerative brake device cannot generate the regenerative braking force, the piston is caused to be located at the standby position when a brake operation member is being operated or when the brake operation member is not being operated and an accelerator operation member is not being operated, even if no request for the electric braking force is made.
